(19) United States
(12) Patent Application Publication
(10) Pub. No.: US 2010/0295794 A1
(43) Pub. Date: Nov. 25, 2010

(54) Two Sided Slate Device

(75) Inventors: Kevin Russ, Bellevue, WA (US); Ian Sands, Seattle, WA (US); Russ Burtner, Everett, WA (US); John Snavely, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/469,592

(22) Filed: May 20, 2009

(51) Int. Cl. G06F 3/041

(52) U.S. Cl. 345/173

(57) ABSTRACT

Embodiments of the present invention provide a dual-sided multi-touch computing device that offers the advantages of a keyboard in addition to the conveniences of a slate device. The dual-sided multi-touch computing device may be utilized in two orientations; one side is a multi-touch slate device, and the alternate side is a multi-touch display keyboard. The device is configured with an orientation-recognition device, so that it may be configured based on its orientation. The present invention may be utilized as a stand alone personal computer or as a peripheral device in conjunction with other devices.

### BACKGROUND

Interface capabilities between a human and his/her computing device have advanced significantly with the development of digitizing technologies. Using screens as input devices has become increasingly popular. With the influence of recent devices such as slate tablet PCs and many mobile smart phones and personal digital assistants (PDAs), the popularity of multi-touch technology has flourished. Multi-touch interfaces are able to recognize multiple simultaneous touch points, as opposed to standard touchscreen interfaces which only recognize particular touchpoints. While the versatility, mobility, and intuitive interfaces of multi-touch devices lend to the popularity of multi-touch technology, functionality of certain tasks may be compromised. For example, alphanumeric data entry via a screen typically is consistently slower and less accurate when compared with alphanumeric data entry via a keyboard. With mechanical keys on a keyboard, users are able to place their finger on a “home row,” and with practice, learn to navigate the keyboard with little visual or auditory feedback. Mechanical keyboards also provide haptic feedback which may contribute to better accuracy and input times. In most cases, a user cannot feel the key he/she selects when utilizing a screen for input and hence must look at the display while entering data. Accordingly, a user may be more reliant on auditory and visual feedback from the input screen application when self-monitoring for input accuracy. Accuracy and efficiency of data input via a screen may also be compromised due to a user's fingers visually obstructing the screen. Some solutions, such as convertible tablet PCs, integrate a keyboard beneath a swiveling and folding display. Keyboards may also be attached to multi-touch computing devices via a wireless or wireline cable; however, additional peripheral devices subtract from the advantages of a small and portable computing device. It is respect to these and other considerations that the present invention has been made.

### SUMMARY

Embodiments of the present invention are directed to a dual-sided multi-touch computing device providing the advantages of a keyboard with those of a slate device. In one embodiment, the computing device is a stand alone personal computer. One side is a slate device, and the opposite side is a keyboard. The computing device may be utilized in two orientations. In a first orientation, the slate side 202 is face-up and may be interacted with using a pen, stylus, or multi-touch, much like a slate tablet personal computer. In a second orientation, the keyboard side 302 is face-up, allowing for keyboard interaction via displayed keys and additional interaction and visual space via a display area around the displayed keyboard. In the second orientation where the keyboard is face-up and the slate side 202 is down, the slate side may also be active wherein the upwards-facing side (i.e., keyboard side 302) may be interacted with from the back or be used as a virtual mouse.

In another embodiment, the dual-sided multi-touch computing device may be utilized as a peripheral device in conjunction with other devices. For example, the dual-sided multi-touch computing device may be utilized as a primary keyboard input device for a computer, or it may be coupled it with a wall display or surface display.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a block diagram illustrating example physical components of an electronic computing device that may be housed in the dual-sided multi-touch computing device of the present invention.

FIG. 2 is a top-down view of a dual-sided multi-touch computing device with the slate side facing up.

FIG. 3 is a top-down view of the computing device of FIG. 2 oriented with the keyboard side facing up.

FIG. 4 is an edge view of the computing device of FIG. 2 showing an edge of the device running along the bottom of the keyboard side of the device.

FIG. 5 is a top-down view of the computing device of FIG. 2 shown in a non-rectilinear design.

### DETAILED DESCRIPTION

As briefly described above, while slate tablet PCs and other multi-touch devices provide users an intuitive interface in a compact package, the absence of a keyboard presents an inconvenience that may hinder the accuracy and efficiency of alphanumeric data entry. Embodiments of the present invention are directed to a dual-sided multi-touch computing device providing the advantages of a keyboard with those of a slate device. The present invention offers the conveniences of the mobility of a slate device while also providing a slim keyboard with displayed keys.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

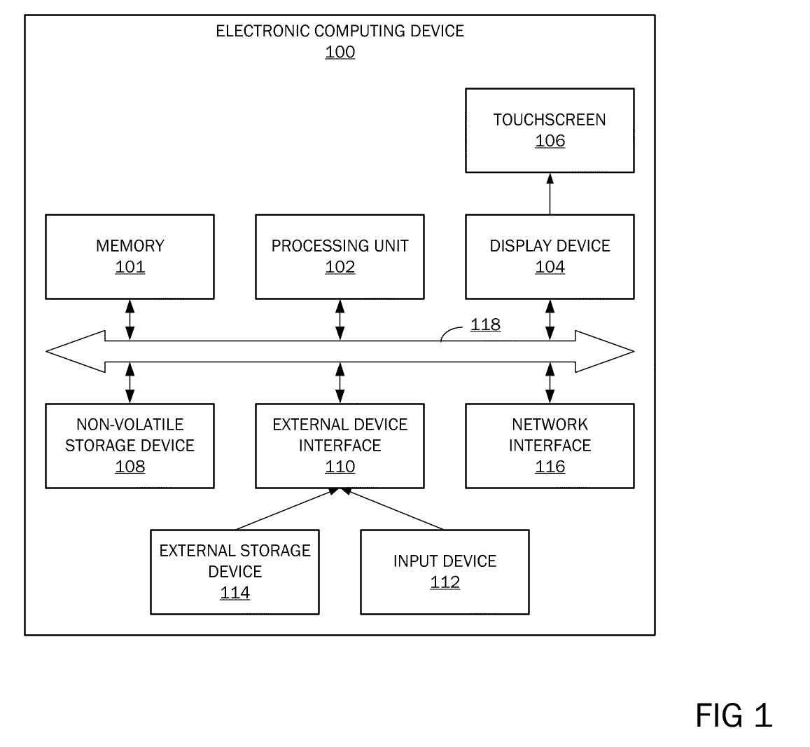

The following is a description of components of a computing device, for example, a dual-sided multi-touch computing device. FIG. 1 is a block diagram illustrating example physical components on an electronic computing device 100 that may be disposed in an interior portion of the dual-sided computing device for providing computing functionality of dual-sided computing devices. As illustrated in the example of FIG. 1, electronic computing device 100 comprises a memory unit 101. Memory unit 101 is a computer-readable data storage medium that is capable of storing data and instructions. Memory unit 101 may be a variety of different types of computer-readable data storage media including, but not limited to, dynamic random access memory (DRAM), double data rate synchronous dynamic random access memory (DDR SDRAM), reduced latency DRAM, DDR SDRAM, DDR3 SDRAM, Rambus RAM, or other types of computer-readable data storage media.

In addition, electronic computing device 100 comprises a processing unit 102. In a first example, processing unit 102 may execute software instructions that cause processing unit 102 to provide specific functionality. In this first example, processing unit 102 may be implemented as one or more processing cores and/or as one or more separate microprocessors. For instance, in this first example, processing unit 102 may be implemented as one or more Intel Core2 microprocessors. Processing unit 102 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 102 may be implemented as an application specific integrated circuit (ASIC) that provides specific functionality. In a third example, processing unit 102 may provide specific functionality by using an ASIC and by executing software instructions.

Electronic computing device 100 also comprises a display device 104 that is operative to display a graphical user interface that provides an interface between a user of the electronic computing device 100 and the operating system or application running thereon. Display device 104 may be a variety of different types of display devices. For instance, display device 104 may be an LCD display panel, a plasma screen display panel, a touch-sensitive display panel, a LED array, or another type of display device.

Electronic computing device 100 also comprises a touchscreen 106 that is configured to input information into the electronic computing device 100. The touchscreen 106 may, for example, be utilized to select a displayed icon or element with respect to the graphical user interface on the display 104 by touching the screen 106 in a location corresponding to the desired icon or element.

In addition, electronic device 100 includes a non-volatile storage device 108. Non-volatile storage device 108 is a computer-readable data storage medium that is capable of storage data and/or instructions. Non-volatile storage device 108 may be a variety of different types of different non-volatile storage devices. For example, non-volatile storage device 108 may be one or more hard disk drives, magnetic tape drives, CD-ROM drives, DVD-ROM drives, Blu-Ray disc drives, or other types on non-volatile storage devices.

Electronic computing device 100 also includes an external component interface 110 that enables client systems and server systems to communicate with external components. As illustrated in the example of FIG. 1, external component interface 110 communicates with an input device 112 and an external storage device 114. In one implementation of electronic computing device 100, external component interface 110 is a Universal Serial Bus (USB) interface. In other implementations of electronic computing device 100, electronic computing device 100 may include another type of interface that enables electronic computing device 100 to communicate with input device and/or output devices. For instance, electronic computing device 100 may include a PS/2 interface. Input device 112 may be a variety of different types of devices including, but not limited to keyboards, mice, trackballs, stylus input devices, touch pads, touch-sensitive display devices, touch-sensitive display screens, or other types of input devices. External storage device 114 may be a variety of different types of computer-readable data storage media including magnetic tape, flash memory modules, magnetic disk drives, optical disc drives, and other computer-readable data storage media.

In addition, electronic computing device 100 includes a network interface 116 that enables electronic computing device 100 to send data to and receive data from a distributed computing network. Network interface 116 may be a variety of different types of network interface. For example, network interface 116 may be an Ethernet interface, a token-ring interface, a fiber optic interface, a wireless network interface (e.g. WiFi, WiMax, etc.), or another type of network interface.

Electronic computing device 100 also includes a communications medium 118 that facilitates communication among the various components of electronic computing device 100. Communications medium 118 may comprise one or more different types of communication media including, but not limited to, a PCI bus, a PCI Express bus, an accelerated graphics port (AGP) bus, an Infiniband interconnect, a serial Advanced Attachment (ATA) interconnect, a parallel ATA interconnect, a Fiber Channel interconnect, a USB bus, a Small Computer System Interface (SCSI) interface, or another type of communications medium.

Several computer-readable data storage media are illustrated in the example of FIG. 1 (i.e. memory unit 101, non-volatile storage device 108, and external storage device 114). Together, these computer-readable data storage media may constitute a single logical computer-readable data storage medium. This single logical computer-readable data storage medium may store instructions executable by processing unit 102. Actions described in the above description may result from the execution of the instructions stored on this single logical computer-readable data storage medium. Thus, when this description says that a particular logical module performs a particular action, such a statement may be interpreted to mean that instructions of the software module cause a processing unit, such as processing unit 102, to perform the action.

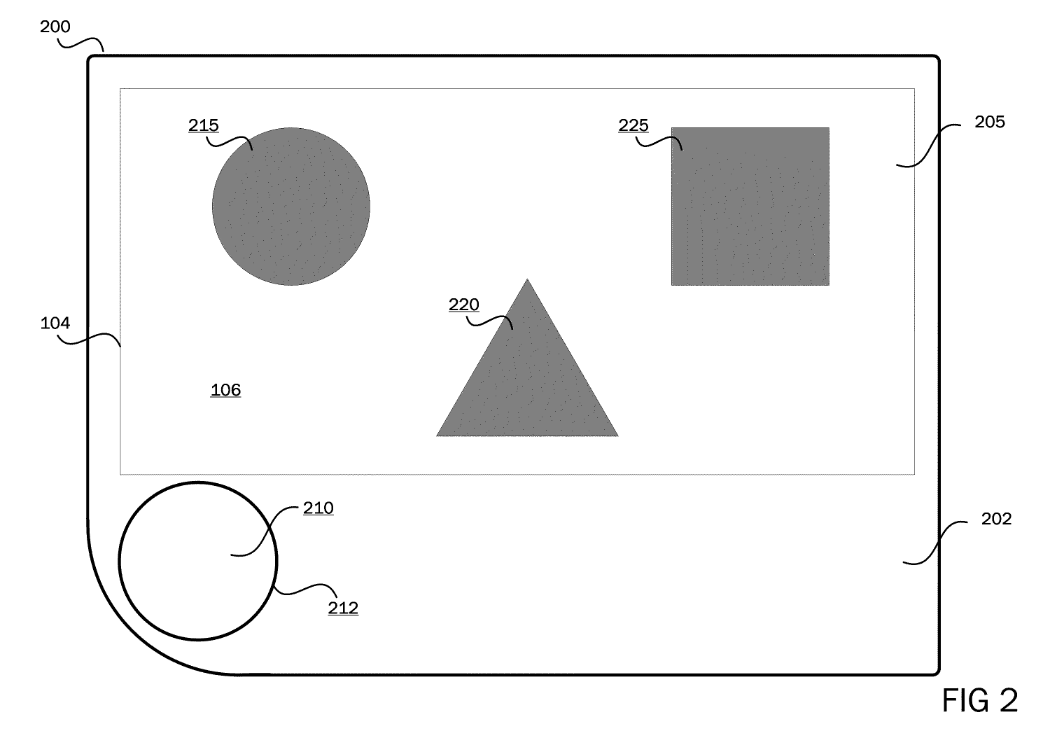

Embodiments of the present invention are directed to a dual-sided multi-touch computing device with multi-touch user interfaces on both sides. FIG. 2 is a top-down view of a dual-sided multi-touch slate device 200 in a first orientation where a slate side 202 is facing up, and a keyboard side is facing down. In the illustrated embodiment in FIG. 2, the slate side 202 of a dual-sided multi-touch computing device 200 is configured with a multi-touch display interface 205 operative to receive input to and output from general purpose computing components housed inside and/or associated with the dual-sided multi-touch computing device. The multi-touch display interface 205 may comprise a display area 104 operative for displaying visual information and a touchscreen 106 positioned on the surface of the display area operative for receiving input signals via touch. A user may interact with the display interface 205 using multi-touch or stylus-based input similar to a tablet PC. As illustrated in FIG. 2, example objects 215,220,225 are displayed in the display area 104. The objects 215,220,225 are examples of any content that may be displayed, edited, or otherwise manipulated including, but not limited to, alphanumeric data, pictures, clipart, etc. The multi-touch interface 205 may comprise a touchscreen 106 that is responsive to mechanical or electrical stimuli through a variety of means, including but not limited to: passive or capacitive digitizing technology, heat, finger pressure, high capture rate cameras, infrared light, optic capture, tuned electromagnetic induction, ultrasonic receivers, transducer microphones, laser rangefinders, shadow capture, and the like. As should be appreciated by those skilled in the art, touch recognition and multi-touch technology are known technologies that will not be discussed at length herein.

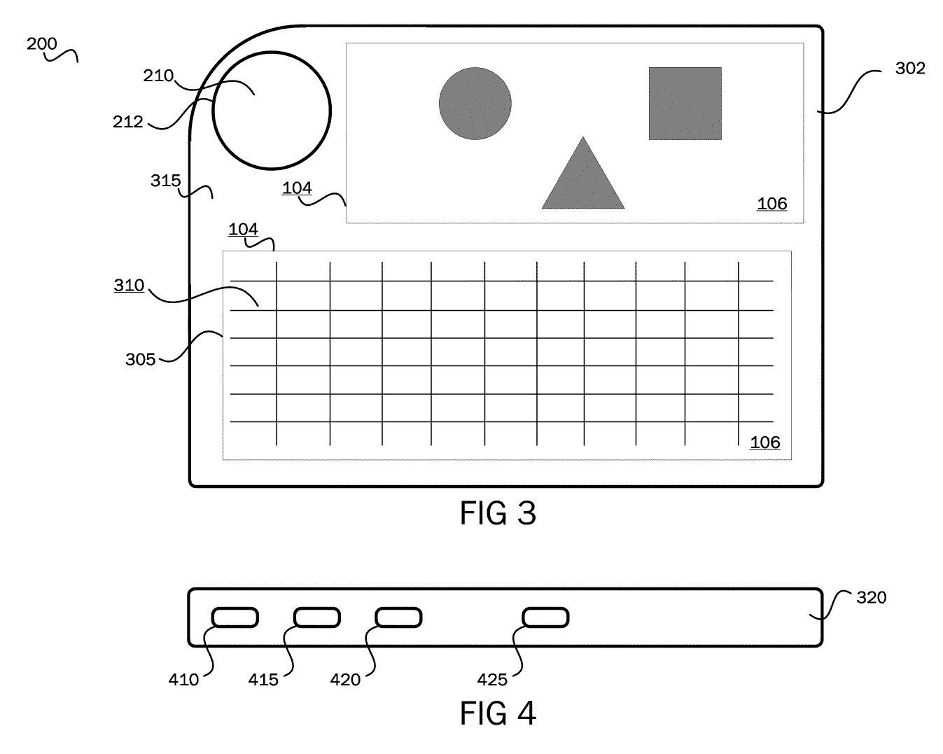

In accordance with another embodiment, on the opposite side of the dual-sided multi-touch computing device 200, a second and third multi-touch interface are provided. In FIG. 3, a second orientation of the device is shown. The second and third multi-touch interfaces 305,315 may be activated for use when the dual-sided multi-touch computing device 200 is oriented such that the second and third multi-touch interfaces 305,315 are facing up. According to an embodiment, when the second and third multi-touch interfaces 305,315 are activated for use, the slate side 202 of the dual-sided multi-touch computing device may be deactivated. The multi-touch keyboard interface 305 comprises a display area 104 operative for displaying keys of a keyboard and a touchscreen 106 positioned on the surface of the display area 104 operative for receiving input signals via touch. The multi-touch keyboard interface 305 may comprise a plurality of display keys 310 disposed on the second multi-touch interface 305 operative to receiving key stroke input to the general purpose computing components housed inside and/or associated with the dual-sided multi-touch computing device 200. The keyboard side 302 may look and work like a standard mechanical keyboard; however, the keys 310 may be displays as opposed to spring-loaded keys. As should be appreciated, the keys 310 displayed on the keyboard side 302 may be displayed according to a variety of styles, for example, QWERTY.

As mentioned previously, conventional keyboard entry is typically a more efficient input method for most common text and numerical data input due to several factors including haptic feedback and unobstructed visual feedback on a screen. According to an embodiment, feedback may be triggered in response to a selection of a display key 310 in an effort to aid in accuracy of data input. The second multi-touch interface 305 (keyboard interface) is operative to provide haptic feedback to a user of the plurality of display keys 310 when any of the plurality display keys is actuated by the user. It should be appreciated that the triggered feedback may be visual feedback (e.g., change in appearance of the selected visual key 310), audible feedback (e.g., played audible tone through speaker), tactile feedback (e.g., vibration), or a combination of such feedback types. In one example, a user may be typing on the display keyboard 305. Each time he/she pushes a display key 310, he/she may feel a slight vibration, hear a relative sound, and/or see the selected display key 310 change in appearance as if it had been depressed. Alternatively, in another example, the dual-sided multi-touch computing device 200 may only provide haptic feedback, for example, vibrating as an example user presses a display key 310. As should be appreciated, various known feedback methods may be incorporated in embodiments of the present invention.

According to one embodiment, the multi-touch keyboard interface 305 may be a smooth, nearly frictionless touch surface. In another embodiment, the keyboard interface 305 may have indicated key edges using raised ridges on the keyboard surface. In another embodiment, tactile feedback mechanisms such as concave depressions, raised dots, bars, or other known mechanisms on some or all keys 310 may be provided.

Another embodiment of the keyboard side 302 of the two-sided multi-touch computing device 200 is an area around the keyboard interface 305 is a third display interface 315. The third multi-touch interface 315 may be operative to serve as an output display for displaying input to the general purpose computing components housed in and/or associated with the dual-sided multi-touch computing device 200 in response to utilization of the multi-touch keyboard interface 305. The third multi-touch interface 315 may provide a visual feedback area for a user to see the text he/she is typing on the multi-touch keyboard interface 305. According to an embodiment, selectable contextual buttons may also be displayed in the third multi-touch interface 315 allowing a user to change the keyboard configuration or program commonly used quick keys. In one embodiment, the display 315 may include a multi-touch interface comprising a display 104 and a touchscreen 106. In another embodiment, display 315 may comprise a display 104 only.

One disadvantage of using touch input on a screen is that a user's fingers may obstruct graphical elements on the screen that he/she wishes to interact with. To address this limitation, in accordance with an embodiment, when the keyboard side 302 is facing upwards, the multi-touch display interface 205 on the slate side 202 may be activated for use. Utilizing technologies like pseudo-transparency technology utilized in the LUCID TOUCH device from MICROSOFT CORPORATION, Redmond, Wash., a user may utilize the multi-touch interface 205 on the slate side 202 to interact with the keys 310 of the multi-touch keyboard interface 305 on the keyboard side 302. According to one embodiment, a user's hands and fingers may be sensed on the reverse side of the device 200 and rendered on the display 104 of the keyboard side 302. By allowing a user to interact with display content by touching the backside of the device 200, obstruction of the keyboard 305 may be reduced, which may result in better input accuracy.

According to another embodiment, when the slate side 202 is facing upwards, the second and third multi-touch interfaces 305,315 on the keyboard side 302 may be activated for use. It should be appreciated that both sides of the dual-sided multi-touch computing device may be activated for use by various methods including, but not limited to, a toggling of a switch, a selection of a menu item, etc.

According to an embodiment, the dual-sided multi-touch computing device 200 may be configured with an orientation-recognition system. It should be appreciated that the orientation-recognition system may use a gyroscope, accelerometer, or other known technology to recognize orientation. When an orientation of the device 200 is recognized, the recognition may be used to make a determination as to which side of the device is facing up and what functionalities a user may want to utilize. For example, if it determined that the device 200 is oriented so that the slate side 202 is facing upwards, keyboard interface 305 input may be disabled to prevent accidental selection of keys 310. If it is determined that the device 200 is oriented so that the keyboard side 302 is facing upwards, the keyboard side may become active and allow for user input.

In accordance with another embodiment, the dual-sided multi-touch computing device 200 may comprise a circular-shaped cut-out 210. The circle cut-out may be used to balance the device 200 with one hand. A user may insert his/her thumb in the circular-shaped cut-out 210, similarly to how a person may hold an artist's palette. According to another embodiment, the circular-shaped cut-out 210 may comprise a capacitive charging means 212 disposed along an interior surface of the circular-shaped cut out for allowing a charging of a battery operatively associated with the dual-sided multi-touch computing device 200 by connecting the capacitive charging means to an associated charging device. According to yet another embodiment, interaction paradigms may be developed around the circle circular-shaped 210 that may mimic a dial or circular slider. In an example scenario, a user may attend a meeting where in an example meeting room, dual-sided multi-touch computing devices 200 may be hanging on a rack. An example user may select a device 200 and utilize it from his/her seat. The device 200 may be coupled with a wall display or a table display, or may be utilized as a stand-alone computing device. Another example user may utilize his/her device 200 as a primary keyboard input device for a computer and then carry it to the example meeting, where it may be coupled with peripheral displays via a wireless interface.

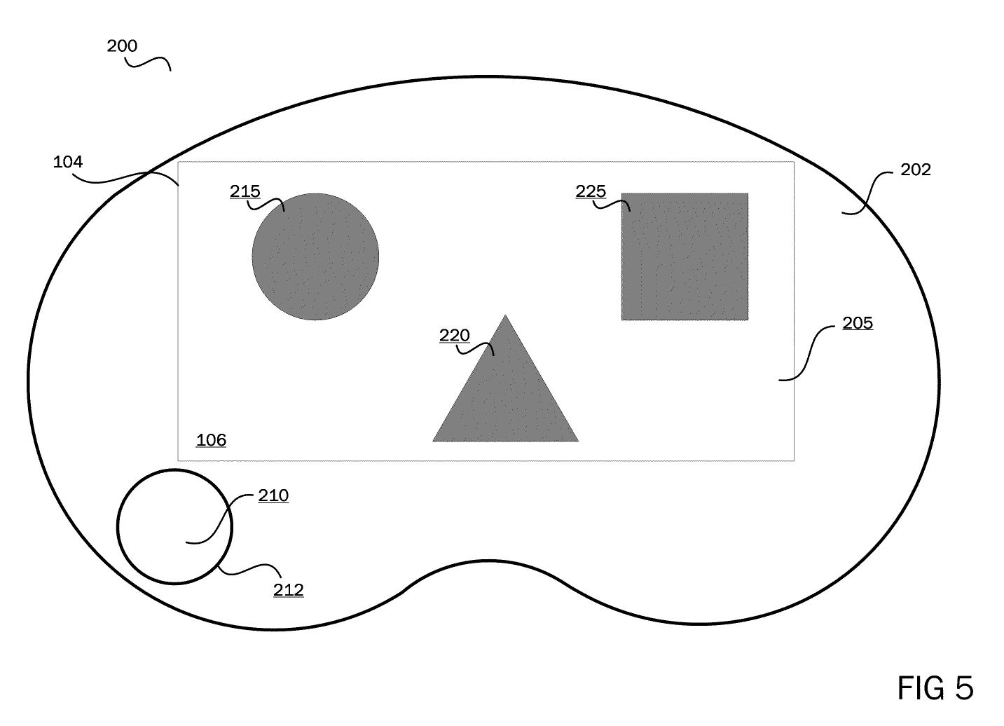

FIG. 4 is an edge view of the dual-sided multi-touch computing device 200 showing an edge of the device running along the bottom of the keyboard side 302 of the device. According to an embodiment, a dual-sided multi-touch computing device 200 may comprise various ports 410,415,420,425, as shown in FIG. 4. The ports 410,415,420,425 may be utilized as a connection method for coupling the device 200 with a plurality of computer peripherals. For example, 410 may be a power plug, ports 415 and 420 may be USB ports, and port 425 may be an Ethernet port. It should be appreciated that a variety of configurations of various ports may be incorporated in a dual-sided multi-touch computing device 200.

The dual-sided multi-touch computing device 200 may be rectilinear in shape as in the embodiments represented in FIGS. 2-4. According to another embodiment, the dual-sided multi-touch computing device 200 may be non-rectilinear in shape. FIG. 5 is an illustration of the dual-sided multi-touch computing device 200 of FIG. 2 configured as a non-rectilinear device. In this illustration, the dual-sided multi-touch computing device 200 is kidney-shaped. As should be appreciated, the dual-sided multi-touch computing device 200 may be designed in various shapes and sizes.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A dual-sided multi-touch computing device, comprising:
a first multi-touch interface disposed on a first side of the dual-sided multi-touch computing device, the multi-touch interface being operative to receive input to and output from general purpose computing components housed inside the dual-sided multi-touch computing device;
a second multi-touch interface configured as a multi-touch keyboard interface and disposed on a second side of the dual-sided multi-touch computing device, the second side of the dual-sided multi-touch computing device being on an opposite side of the dual-sided multi-touch computing device from the first side of the dual-sided multi-touch computing device, the multi-touch keyboard interface being operative for providing input to the general purpose computing components housed inside the dual-sided multi-touch computing device; and
a third multi-touch interface disposed on the second side of the dual-sided multi-touch computing device in proximity to the multi-touch keyboard interface, the third multi-touch interface being operative to receive input to and output from general purpose computing components housed inside the dual-sided multi-touch computing device and being further operative to serve as an output display for displaying input to the general purpose computing components housed inside the dual-sided multi-touch computing device in response to utilization of the multi-touch keyboard interface.

2. The dual-sided multi-touch computing device of claim 1, wherein the first, second and third multi-touch interfaces are each operative as touch screens operative to receive input via physical touching of surfaces of the first, second and third multi-touch interfaces.

3. The dual-sided multi-touch computing device of claim 1,
wherein the first multi-touch interface disposed on a first side of the dual-sided multi-touch computing device is activated for use when the dual-sided multi-touch computing device is oriented such that the first multi-touch interface is facing up; and
wherein the second and third multi-touch interfaces are activated for use when the dual-sided multi-touch computing device is oriented such that the second and third multi-touch interfaces are facing up.

4. The dual-sided multi-touch computing device of claim 3,
wherein when the first side of the dual-sided multi-touch computing device is activated for use, the second and third multi-touch interfaces are deactivated from use; and
wherein when the second and third multi-touch interfaces are activated for use, the first side of the dual-sided multi-touch computing device is deactivated from use.

5. The dual-sided multi-touch computing device of claim 4, comprising an orientation-sensing means operative to recognize an orientation of the dual-sided multi-touch computing device for determining when the dual-sided multi-touch computing device is oriented such that the first multi-touch interface is facing up and when the dual-sided multi-touch computing device is oriented such that the second and third multi-touch interfaces are facing up.

6. The dual-sided multi-touch computing device of claim 1, wherein each of the first, second and third multi-touch interfaces are active for user interaction concurrently.

7. The dual-sided multi-touch computing device of claim 1, wherein the multi-touch keyboard interface comprises a plurality of display keys disposed on the second multi-touch interface for receiving key stroke input to the general purpose computing components housed inside the dual-sided multi-touch computing device.

8. The dual-sided multi-touch computing device of claim 7, wherein the second multi-touch interface is operative to provide haptic feedback to a user of the plurality of display keys when any of the plurality of display keys is actuated by the user.

9. The dual-sided multi-touch computing device of claim 1, comprising a generally circular-shaped cut-out for providing a means for holding the dual-sided multi-touch computing device.

10. The dual-sided multi-touch computing device of claim 9, further comprising a capacitive charging means disposed along an interior surface of the cut-out for allowing a charging of a battery operatively associated with the dual-sided multi-touch computing device by connecting the capacitive charging means to an associated charging device.

11. A dual-sided multi-touch computing device, comprising:
a first multi-touch interface disposed on a first side of the dual-sided multi-touch computing device, the multi-touch interface being operative to receive input to and output from general purpose computing components associated with the dual-sided multi-touch computing device;
a second multi-touch interface configured as a multi-touch keyboard interface and disposed on a second side of the dual-sided multi-touch computing device, the second side of the dual-sided multi-touch computing device being on an opposite side of the dual-sided multi-touch computing device from the first side of the dual-sided multi-touch computing device, the multi-touch keyboard interface being operative for providing input to the general purpose computing components associated with the dual-sided multi-touch computing device;
a third multi-touch interface disposed on the second side of the dual-sided multi-touch computing device in proximity to the multi-touch keyboard interface, the third multi-touch interface being operative to receive input to and output from general purpose computing components associated with the dual-sided multi-touch computing device and being further operative to serve as an output display for displaying input to the general purpose computing components associated with the dual-sided multi-touch computing device in response to utilization of the multi-touch keyboard interface;
wherein the first multi-touch interface disposed on a first side of the dual-sided multi-touch computing device is activated for use when the dual-sided multi-touch computing device is oriented such that the first multi-touch interface is facing up; and
wherein the second and third multi-touch interfaces are activated for use when the dual-sided multi-touch computing device is oriented such that the second and third multi-touch interfaces are facing up.

12. The dual-sided multi-touch computing device of claim 11, wherein the first, second and third multi-touch interfaces are each operative as touch screens operative to receive input via physical touching of surfaces of the first, second and third multi-touch interfaces.

13. The dual-sided multi-touch computing device of claim 11,
wherein when the first side of the dual-sided multi-touch computing device is activated for use, the second and third multi-touch interfaces are deactivated from use; and
wherein when the second and third multi-touch interfaces are activated for use, the first side of the dual-sided multi-touch computing device is deactivated from use.

14. The dual-sided multi-touch computing device of claim 13, comprising an orientation-sensing means operative to recognize an orientation of the dual-sided multi-touch computing device for determining when the dual-sided multi-touch computing device is oriented such that the first multi-touch interface is facing up and when the dual-sided multi-touch computing device is oriented such that the second and third multi-touch interfaces are facing up.

15. The dual-sided multi-touch computing device of claim 11, wherein each of the first, second and third multi-touch interfaces are active for user interaction concurrently.

16. The dual-sided multi-touch computing device of claim 11, wherein the multi-touch keyboard interface comprises a plurality of display keys disposed on the second multi-touch interface for receiving key stroke input to the general purpose computing components associated with the dual-sided multi-touch computing device.

17. The dual-sided multi-touch computing device of claim 15, wherein the second multi-touch interface is operative to provide haptic feedback to a user of the plurality of display keys when any of the plurality of display keys is actuated by the user.

18. The dual-sided multi-touch computing device of claim 1, comprising a generally circular-shaped cut-out for providing a means for holding the dual-sided multi-touch computing device.

19. The dual-sided multi-touch computing device of claim 9, further comprising a capacitive charging means disposed along an interior surface of the cut-out for allowing a charging of a battery operatively associated with the dual-sided multi-touch computing device by connecting the capacitive charging means to an associated charging device.

20. A dual-sided multi-touch computing device, comprising:
a first multi-touch interface disposed on a first side of the dual-sided multi-touch computing device, the multi-touch interface being operative to receive input to and output from general purpose computing components associated with the dual-sided multi-touch computing device;
a second multi-touch interface configured as a multi-touch keyboard interface and disposed on a second side of the dual-sided multi-touch computing device, the second side of the dual-sided multi-touch computing device being on an opposite side of the dual-sided multi-touch computing device from the first side of the dual-sided multi-touch computing device, the multi-touch keyboard interface being operative for providing input to the general purpose computing components associated with the dual-sided multi-touch computing device;
a third multi-touch interface disposed on the second side of the dual-sided multi-touch computing device in proximity to the multi-touch keyboard interface, the third multi-touch interface being operative to receive input to and output from general purpose computing components associated with the dual-sided multi-touch computing device and being further operative to serve as an output display for displaying input to the general purpose computing components associated with the dual-sided multi-touch computing device in response to utilization of the multi-touch keyboard interface;
wherein the first multi-touch interface disposed on a first side of the dual-sided multi-touch computing device is activated for use when the dual-sided multi-touch computing device is oriented such that the first multi-touch interface is facing up;
wherein the second and third multi-touch interfaces are activated for use when the dual-sided multi-touch computing device is oriented such that the second and third multi-touch interfaces are facing up; and
further comprising an orientation-sensing means operative to recognize an orientation of the dual-sided multi-touch computing device for determining when the dual-sided multi-touch computing device is oriented such that the first multi-touch interface is facing up and when the dual-sided multi-touch computing device is oriented such that the second and third multi-touch interfaces are facing up.
